(19) United States
(12) Patent Application Publication
(10) Pub. No.: US 2015/0156455 A1
(43) Pub. Date: Jun. 4, 2015

(54) SYSTEM AND METHOD FOR ENABLING REALTIME REMOTE COMMUNICATION IN THE MEDICAL FIELD

(71) Applicant: Michael J. Maresca, JR., Ramsey, NJ (US)

(72) Inventor: Michael J. Maresca, JR., Ramsey, NJ (US)

(21) Appl. No.: 14/559,664

(22) Filed: Dec. 3, 2014

Related U.S. Application Data
(63) Continuation-in-part of application No. 12/217,270, filed on Jul. 1, 2008.
(60) Provisional application No. 61/911,270, filed on Dec. 3, 2013.

(51) Int. Cl. H04N 7/15

(52) U.S. Cl. CPC H04N 7/15

(57) ABSTRACT

A system for providing full motion, high frame rate video, well synchronized audio, and transmission of additional data between two or more parties including at least one provider and at least one user of a medical service.

### CROSS-REFERENCE TO RELATED APPLICATION

This non-provisional application claims priority to U.S. Provisional Patent Application Ser. No. 61/911,270 filed Dec. 3, 2013, entitled System and Method for Enabling Real Time Remote Communication in the Medical Field, and is a continuation of U.S. patent application Ser. No. 12/217,270, filed Jul. 1, 2008, entitled Duplex Enhanced Quality Video Transmission Over Internet, the entireties of which are incorporated herein by reference as if fully set forth herein.

### BACKGROUND

1. Field of the Invention

This invention relates to a method and system for the virtual interaction between medical care providers, medical patients, and medical specialists. More particularly, this invention relates to the visual and audible interaction between medical care providers, medical patients, and medical specialists via web enabled devices. Further, the invention relates to a method and system for transmission of full motion video, audio, and diagnostic data between medical care providers, medical patients, and medical specialists to aid and facilitate medical treatment between remote parties.

2. Background of the Invention

The use of existing hardwired communications networks to transmit video as well as voice communications is well known, and has been practiced for several decades. However, prior art systems have typically been very expensive, or have had limitations such as only allowing transmission of images with noticeable delays, poor transmission quality, or both. Full motion video, and especially interactive video, requires the delivery of a very significant amount of data in a relatively uninterrupted stream, which has proven difficult to accomplish over existing telephonic and computer networks.

Integrated Services Digital Network (ISDN) lines have been used for video transmission, with some success, as disclosed in publications such as U.S. Pat. No. 5,371,534, No. 5,751,339, and No. 5,184,345. While this has resulted in much improved transmission quality, the expense of ISDN lines remains a formidable obstacle to their wide use.

An alternative to the transmission of video data over ISDN lines is the use of standard twisted pair copper wire telephone lines, or via the Internet or other computer networks. A viable solution using existing telephone networks was achieved by the Applicant previously, and is protected by U.S. Pat. No. 6,181,693, issued Jan. 30, 2001.

A solution using the Internet or other computer networks to deliver full-motion, live, full duplex transmission of broadcast or near broadcast quality video has been unsolved until now. The Internet relies on grouping the data to be transmitted over it into small component packages of data called packets. These packets are, in general, of unequal length and contain information to indicate where they begin and end, as well as source and destination information. Packets from diverse sources travel over the Internet together and, thus must be recognized at any intermediate switching point and at their final destination points for recombination with other properly associated packets, if successful transmission is to occur. The packeting methodology by its very nature leads to potential delays in transmission and processing, and a degradation in the quality of the transmission. In addition, the ever growing number of users on the Internet has compounded the delay in transmission. Such delays and degradation in quality, although generally not critical in voice communications or in unidirectional video communications, are less tolerable in applications requiring a high data transmission rate such as full-motion, live, full duplex video transmission, particularly if broadcast quality or near broadcast quality video is required. By and large, bidirectional video communication has suffered from both severe latency as well as poor image quality.

The present invention enables the Internet or other computer network to be used to deliver full-motion, live, full duplex transmission of broadcast or near broadcast quality video to anyone having conventional high-speed Internet access.

Inexpensive video conferencing, particularly given the security available with a secure client peer-to-peer connection, is compatible with the needs of many industries, including the medical industry, which in the past has had justifiable concerns about transmitting information over the Internet.

The most obvious beneficiaries of the present invention are individuals who, with the availability of a means to capture video, can, through the use of the present invention, employ a conventional high-speed Internet connection to communicate with another person or a group of others, in broadcast or near-broadcast quality video.

In particular, conventional methods for patients to receive medical aid and diagnoses require doctors and patients to be in the same location. In non-emergency situation, patients typically schedule appointments with their medical providers for routine medical “checkups”, need medical care, or when they fall ill. Once said appointments are scheduled, patients travel to the care providers so they may be diagnosed and potentially treated. During scheduled medical appointments, Medical Providers often inspect patients visually and with a number of medical instruments which provide data, to ascertain a patient's medical condition. Once a patient's condition is established, medical providers can give their recommended course of action.

In certain cases, patients are referred to a medical provider specializing in their condition, which often requires a new appointment and further travel to the specialist's location. The existing method for interaction between medical providers and patients in a non-emergency situation has several limitations. Requiring potentially ill patients to travel to a medical provider is potentially dangerous and could cause further harm. Additionally, medical providers are not always functioning at their most efficient levels under the conventional interaction method. In the event a patient cancels an appointment, there is the possibility that their time slot with the medical provider is not filled by another patient and therefore wasted. A situation as described causes medical providers to function at a less than optimal level. In a hospital environment or emergency situation, patients often require frequent monitoring throughout their stay. High numbers of patients often cause hospital workers and medical providers to struggle to adequately monitor and interact with each patient in a timely manner.

The medical industry will, if it chooses, have the ability to facilitate visual and audible interaction between medical care providers and patients using internet connected computer of mobile devices. The use of live video interaction has not yet been implemented in the medical world for such use. The introduction of such technology to the industry will potentially increase efficiency numbers and benefit both medical providers and medical patients. Prior to this invention, medical providers were more constricted as to the number of patients they could examine in a given time period.

### SUMMARY

The present invention comprises means for capturing video and associated audio signals, packetizing the same, transmitting the packets as a smooth continuous stream of video and audio data over the Internet, unpacking the data laden packets, and reassembling the data as video and well-synchronized associated audio at the desired recipient location to provide jitter-free full motion video with well-synchronized sound. In an embodiment, two parties can enjoy full duplexed interactivity such as a real time video call. In an alternative embodiment, the present invention also permits combining such packet streams to travel among a plurality of locations, so that there is interactivity not only between a one sender and one receiver, but between a plurality of parties.

To accomplish the duplex or multi-party enhanced quality transmission of the video and audio data between source(s) and destination(s), the present invention is capable of functioning over a private Internet backbone decoupled from the conventional Internet, that transmits packets without the latency incurred by communications over the conventional Internet. For example, the private backbone may be provided under contract with a bulk capacity provider, preferably by reserving capacity on the Internet fiber optic backbone. Equipment can be placed at the headends and/or points of presence of locally provided high-speed Internet access, that detects the packets used in the disclosed system, and redirects those packets to bypass the conventional Internet. Preferably, signals produced at user locations, such as audio/video signals, signals from medical devices, and the like, are packetized by user equipment at the user locations, although packets may alternatively be formed by the system equipment placed at the headends and/or points of presence. Preferably, packets are formed having a fixed length, including fixed length fields, so that packets may be formed and unpacked quickly; some or all of the routing may be predetermined so the packets need not be examined for source and destination at some or all of the private backbone nodes; and a connectionless transmission model with no handshaking or packet-based error correction is preferably used to minimize latency even further. In combination, these features provide smooth, broadcast quality full motion video and well-synchronized audio, that can be used by anyone with a conventional high-speed Internet connection without any added equipment.

In its simplest form, a user has at his or her location a means to capture video imagery and the associated audio and convert it to a digital signal, and a means to convert a received digital signal into a presentation of video imagery and the associated audio. These means are generally well-known in the art and would include devices such as a microphone, a camera, a video/audio encoder/decoder, a monitor, and a speaker. In general the means are either integral in or can be made available by employing a personal computer (“PC”). In accordance with the present invention, the transmitted or received video signal is transmitted to or received from the Internet in packets of predetermined, preferably equal length. Each packet is generally encoded with the following information: (1) information indicating the beginning and the end of the packet, (2) information indicating the length of the packet, (3) information indicating the algorithm used to encode the audio/video data, and (4) the encoded audio/video data itself.

Thus, even before the audio/video data leaves the location of the sender, it has been transformed into packets to be transmitted over the Internet or other computer network, and the audio/video data remains in packet form until it arrives at the location of the receiver.

The packet stream is routed to the recipient who has the apparatus, software or both designed in accordance with the present invention to capture the data and convert the packets to an audio/video signal which is in turn displayed on a video device with accompanying audio projected. This generally is a PC.

Since the transmission and reception of the packets is based on a first in/first out protocol, as packets are pulled out to be transmitted or received, they are immediately replaced with the next packets required to be transmitted or received. As a consequence, the sequence is maintained in a relatively uninterrupted manner. Although it is indeed preferable to transmit and receive all data without any error, the system of the present invention need not transmit and receive 100% of the data since an acceptable, indeed very high quality video signal will be enabled even with a loss of some data from the stream of data.

The present invention thus provides for the transmission and reception of full motion, full duplex, live video data and accompanying audio data over the Internet or other computer network, with the concomitant benefit of permitting parties at remote locations to visually and audibly communicate with each other. As well, if one of the parties to the connection is a television studio originating a video broadcast, the video communications received will be and can be transmitted and received between any two points served by the conventional telephone network, at a cost which does not deter widespread use.

This is accomplished through the use of a preferential Internet backbone, a preferential route supplied by arrangement with a data network provider, using fiberoptic lines that are carrying reduced data traffic. This provides for great bandwidth for the bidirectional transmission of video between two or more users.

When an authorized user logs on, a Network Operation Center (“NOC”) verifies both the user and the other users authorized to receive video from and send video to each other. The NOC provides applicable addresses of other users to which each user may connect. If there are only two users, the system will place them into a peer-to-peer connection, for enhanced speed, reliability, and security.

In an additional embodiment, where more than two users are to be connected, the system creates a meeting room, a virtual location where the users of the system “meet.” By use of a multiplexing system the NOC permits all users to have the same transmission rates of data and as more specifically described permits certain supplementary enhancements, such as featuring a larger image of the person then speaking.

In an additional embodiment, a room system may also connect to the videoconference system. A room system is a videoconferencing station that typically includes large monitors with a wide-angle camera and serves groups of people who meet in a room and conference with other groups at remote locations. If the room system has an Internet connection, it would connect to the videoconference system in a manner similar to that used by a personal computer. In such a case, if there was only one other user, the connection would be peer-to-peer, whereas if there were three or more total users, the connection would be made through a meeting room at the NOC. If the room system does not have an Internet connection, but instead has a private network, then it would connect to the NOC through a hardware bridge.

These and other objects and advantages of the present invention will become more apparent to those of ordinary skill in the art upon consideration of the attached drawings and the following description of the preferred embodiments which are meant by way of illustration and example only, but are not to be construed as in any way limiting the invention disclosed and claimed herein.

The present invention includes at least a computer-implemented engine, system and method for allowing the visual and audio communication between at least one provider and at least one user of a medical service.

### BRIEF DESCRIPTION OF THE DRAWINGS

The accompanying drawings are included to provide a further understanding of the disclosed embodiments. In the drawings, like numerals represent like elements, and:

FIG. 1 illustrates an aspect of an exemplary embodiment of the present invention;

FIG. 2 illustrates an aspect of an exemplary embodiment of the present invention;

FIG. 3 illustrates an aspect of an exemplary embodiment of the present invention demonstrating the transmission of full motion duplex video and audio between a medical patient and medical care provided in conjunction with digital data from a medical device;

FIG. 4 illustrates an aspect of an exemplary embodiment of the present invention demonstrating the unilateral transmission of audio and video, in conjunction with digital data from a medical device, from a medical patient to a medical care provider;

FIG. 5 illustrates an aspect of an exemplary embodiment of the present invention demonstrating the transmission and flow of audio, video, and digital data from a medical device, between a medical patient, a medical care provider, and a medical specialist;

FIG. 6 illustrates an aspect of an exemplary embodiment of the present invention demonstrating the direct point to point transmission method of audio, video, and data between two parties;

FIG. 7 illustrates an aspect of an exemplary embodiment of the present invention demonstrating the direct point to point transmission method of audio, video, and data between multiple parties; and

FIG. 8 illustrates an aspect of an exemplary embodiment of the present invention demonstrating the transmission method of audio, video, and data, when being directed through a video conferencing provider as an intermediary.

FIG. 9 is a schematic diagram showing an embodiment of bidirectional transmission of video between two users, where each is using a personal computer via an Internet path.

FIG. 10 is a schematic diagram showing an embodiment of bidirectional transmission of video between two users, where one is using a personal computer with an Internet connection and the other is using a room system with a private network.

FIG. 11 is a schematic diagram showing an embodiment of bidirectional transmission of video between three or more users, where each user accesses a meeting room.

### DETAILED DESCRIPTION

The present invention is a system for duplex enhanced quality bidirectional video transmission over an Internet backbone. Among the improvements in the duplex enhanced quality video transmission system of the present invention is better performance while eliminating the need for specialized hardware.

Computer-implemented platforms, engines, systems and methods of use are disclosed that provide networked access to a plurality of types of digital content, including but not limited to video, audio, metadata, interactive and document content, and that track, deliver manipulate, transform and report the accessed content. Described embodiments of these platforms, engines, systems and methods are intended to be exemplary and not limiting. As such, it is contemplated that the herein described systems and methods can be adapted to provide many types of cloud-based valuations, scoring, marketplaces, and the like, and can be extended to provide enhancements and/or additions to the exemplary platforms, engines, systems and methods described. The invention is thus intended to include all such extensions. Reference will now be made in detail to various exemplary and illustrative embodiments of the present invention.

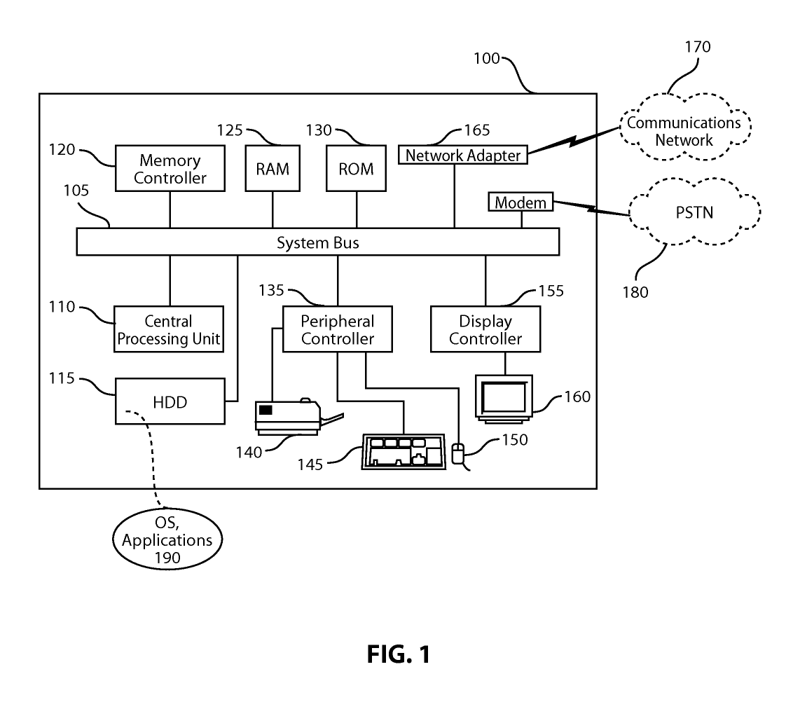

FIG. 1 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

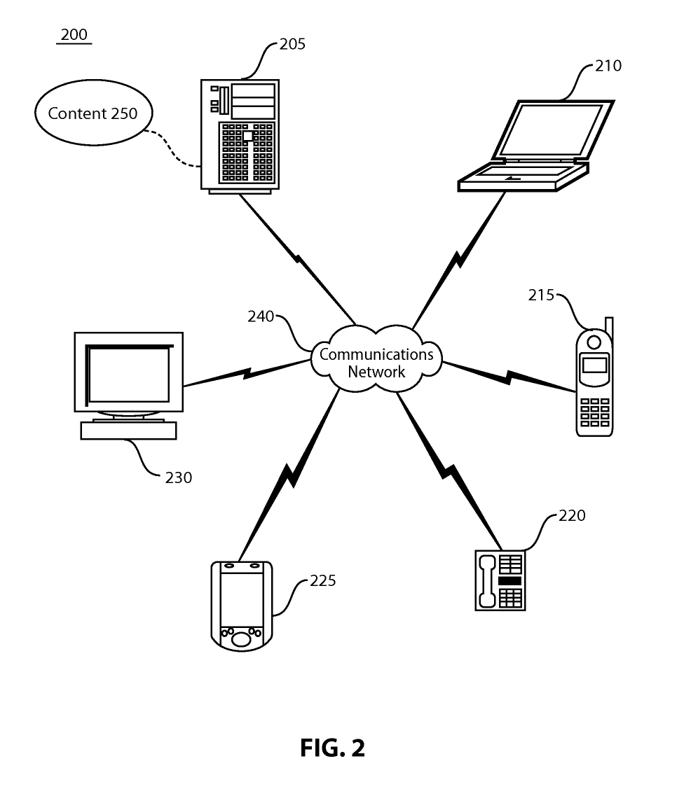

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

The present invention is a method of providing visual and audible feeds between medical providers, medical patients, and medical specialists. The method for creating such an environment is through the use of protocols which are provided by an HD Video Conferencing Provider and utilized by web enabled devices. The HD Video Conferencing Provider's protocols or system will create the visual and audible interaction between the parties which will be enhanced by the transmission of data from diagnostic medical equipment from the patient to the Medical Provider.

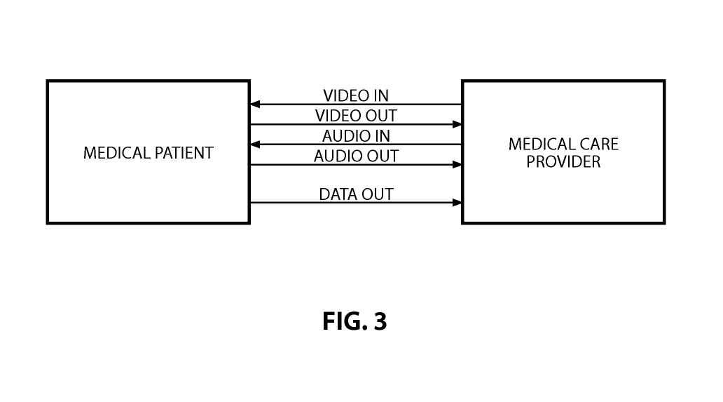

All transmission of audio, video and data may be facilitated through video conferencing provider software and/or hardware. Such data can originate from but is not limited to any digital diagnostic device which can provide data or information to medical care providers. The data from said digital devices along with the video and audio feeds being delivered to the medical provider will aid in the diagnosis and/or monitoring of the patient. The transmission of video and audio can function in a full motion duplex manner during which both the medical care provider and medical patient transmit and receive video and audio as seen in FIG. 3. This form of interaction may be enhanced by the transmission of data from a digital medical device at the patient's location.

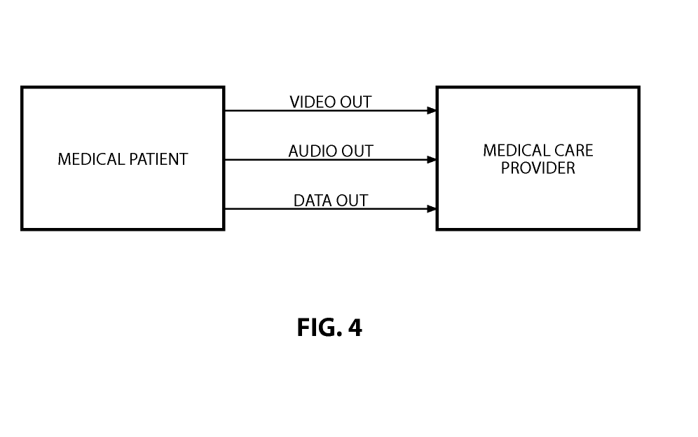

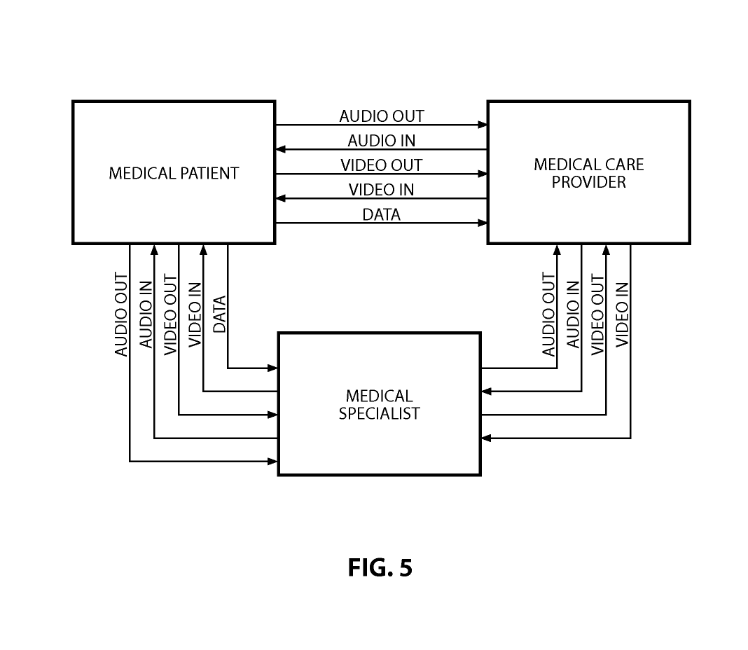

As illustrated in FIG. 3, the transmission of video and audio may happen in a unilateral manner either from the medical care provider to the patient or from the medical patient to the medical care provider. This form of interaction may be enhanced by the transmission of data from a digital medical device at the patient's location as illustrated in FIG. 4. The Transmission of audio, video, and data may occur between multiple parties as illustrated in FIG. 5. The transmission of audio, video, and data occurs through use of protocols or systems provided by a video conferencing provider.

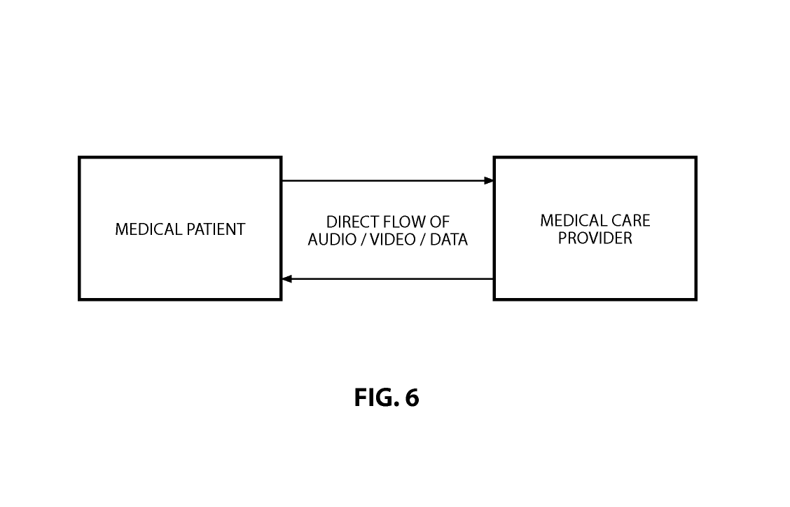

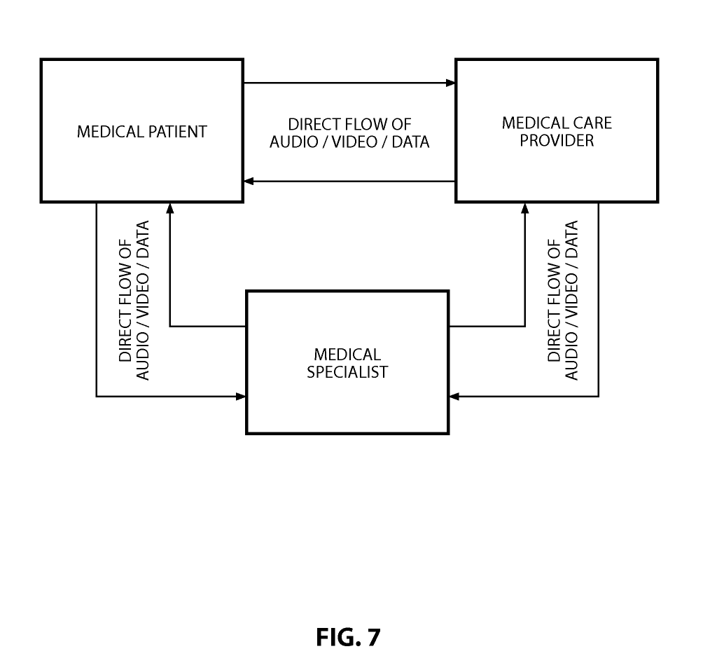

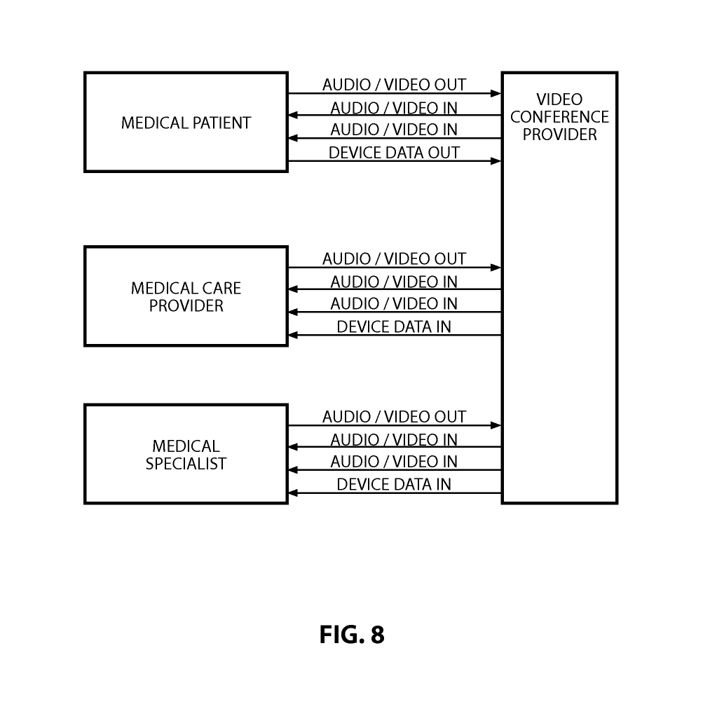

The transmission of audio, video, and data can occur between two parties in a direct point to point connection between end parties as outlined in FIG. 6. The transmission of audio, video, and data can occur between multiple parties in a direct point to point connection between end parties as outlined in FIG. 7. The transmission of audio, video, and data can occur between two parties by transmitting data to a video conferencing provider which is then transmitted to each respective end user as outlined in FIG. 8. The Transmission of data may occur whenever the patient has a digital device as outlined in section A(1). The transmission of video and audio may occur wherever the patient may be, provided they have an appropriate web enabled device, computer, or mobile device, as outlined in section A(2) or A(3).

In its full form the medical information transmission system at the patient's location will have the following capabilities, 1) transmit HD Video to medical providers 2) transmit Audio to medical providers 3) receive data from digital diagnostic medical devices and transmit the data in conjunction with said transmitted video 4) receive video from medical providers 5) receive audio from medical providers. In its full form the medical information transmission system at the medical provider's location will have the following capabilities 1) transmit HD video to medical patients 2) transmit audio to medical patients 3) receive data from medical patients from digital diagnostic medical devices 4) receive HD video from medical patients 5) receive audio from medical patients 6) transmit HD video to medical specialists 7) transmit audio to medical specialists, and 8) transmit data received from medical patients from digital diagnostic medical devices to medical specialists. The transmission of video and audio occurs in the following steps 1) light enters a camera lens and is captured, for example, on a charged coupled device, and sound enters a microphone 2) The microphone creates a digitized sound signal and the charged coupled device creates a digital image signal and 3) the digital sound and digital image information are transferred to an encoding process where the audio and video data are converted into a standards based multimedia signal 4) the multimedia signal is then transferred to a packeting process (for example, as described in WO2000021258, entitled “High speed video transmission over telephone lines” to M. Maresca, incorporated by reference) 5) the packets are then transmitted electronically using proprietary or standards based transmission methodologies, such as tcpip/udp, for receipt by the remote system 6) the packets are then de-packetized and assembled into a standards based block of digital information 7) the block of information is broken down into raw data which can then be mapped onto a video display [monitor] for viewing by the recipient 8) in the event of multi-party interaction, the raw data is mapped into a large segment video memory block where it is combined with raw data from additional sources to create a multiplexed, multi-source display of a plurality of participants. The full motion video is delivered to each end user providing a fully visual auction experience.

The data from digital medical devices is transmitted in the following steps 1) data is collected by the medical device 2) data is digitized and transferred to a packeting process (for example as described in WO2000021258, entitled “High speed video transmission over telephone lines” to M. Maresca) 3) the packetized digital information is transmitted electronically using one of a proprietary or a standards-based transmission methodology such as tcpip/udp for receipt by the remote system 4) the information is then de-packetized and the digital information assembled into the digitized medical data 5) which can then be mapped onto a video display [monitor] for viewing by the recipient.

In a non-emergency environment, medical providers may choose to accept medical appointments over the virtual system. The system is set to the doctor's specific scheduling specifications. At the time of appointment, a website link is emailed to the patient. When the website link is opened, a portal is opened by the video conferencing provider to allow the visual and audible interaction between parties.

A(1) Requirements for transmission of data from a digital medical device from a medical patient: Patients can transmit data from a digital medical device through video conferencing software provided that their medical device 1) collects data 2) creates data in a digital form 3) has either a wired or wireless connection to a computer or mobile device as outlined in A(2) or A(3).

A(2) Requirements for Participation or Two Way Interaction between Medical Care Providers, Medical Patients, and Medical Specialists using a computer device: Users can visually and audibly interact with each other provided that the computer or mobile phone is equipped with A) an internet connection B) web enabled Camera C) computer enabled microphone D) monitor or display E) computer enabled speakers E) said device is currently running Microsoft Windows or Mac OS operating system and F) Basic Video Processing Ability.

A(3) Requirements for Participation or Two Way Interaction between Medical Care Providers, Medical Patients, and Medical Specialists using a mobile device: Users can visually and audibly interact with each other using a mobile device provided that the mobile device is equipped with A) an internet connection B) web enabled Camera C) a functional microphone D) A functional display E) a functional speakers E) said device is currently running a version of Android, Mac or windows operating system and F) Basic Video Processing Ability.

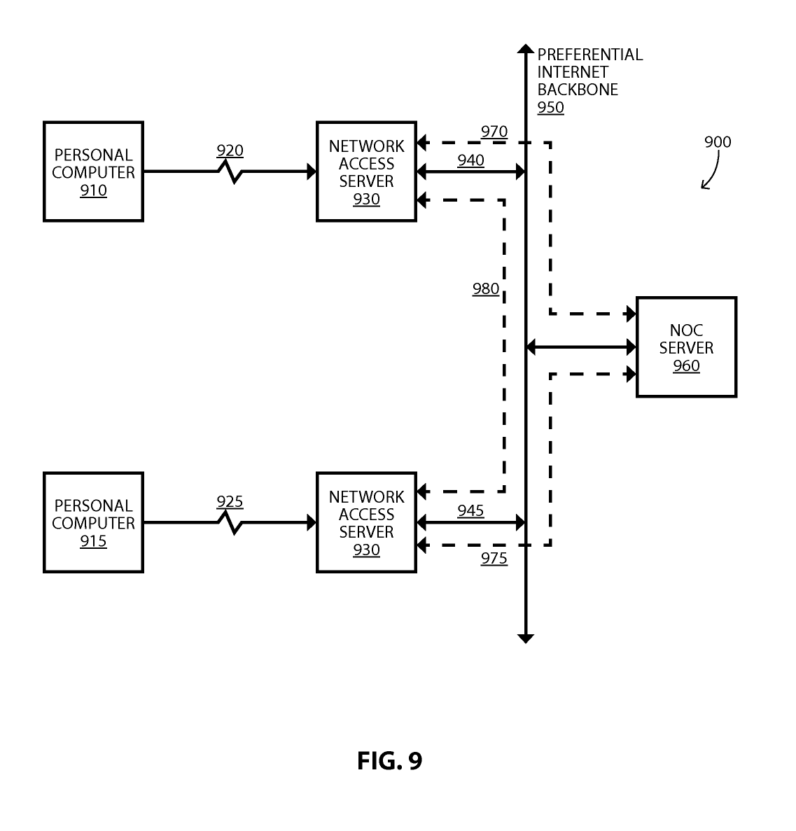

FIG. 9 shows an implementation of a system 900 featuring bidirectional transmission of video between two users, with each using a personal computer via an Internet path. Generally, the system 900 includes: personal computers 910 and 915; a network access server 930; a network operation center (“NOC”) server 960; and an Internet network 950.

Personal computer 910 may be a desktop computer, laptop, workstation or router, that is capable of connecting into the network access server 930 to establish a session 920. Personal computer 910 incorporates a secure client desktop software containing a computer network authentication protocol employing strong encryption, preferably IPsec. This Internet security protocol allows for cryptographic key establishment and authenticating and/or encrypting each IP packet in a data stream. IPsec or other like protocol is preferable because it functions at the network layer, which gives it more flexibility than many other security protocols in common use, such as SSH, SSL/TL and Kerberos, which operate on the transport layer. This difference allows IPsec to secure packet flows.

The secure client connects to a website hosted by network access server 930, where the user's identity is confirmed. The network access server 930 is a computer, or a group of hardware or software components or processes that execute in one or more computer systems.

The secure client and network access server 930 then create an encrypted network tunnel from the user's computer to a Network Operation Center (“NOC”) server 960, via a private Internet backbone 950. This preferential Internet backbone 950 is a preferential route supplied by arrangement with a data network provider, using fiber optic lines that are reserved to carry specially routed traffic, thus providing for greater available bandwidth for the bidirectional transmission of video between two or more users of the system.

The network access server 930 controls remote access to the preferential Internet backbone 950 and to the NOC server 960, along route 970, forwarding the password that has been supplied by the user at personal computer 910 to the network access server 930.

The NOC server 960 is a computer, or a group of hardware or software components or processes that execute in one or more computer systems. In part, the NOC server 960 performs authorization and authentication functions. The NOC server 960 has a directory established for each user, containing identification and password information and a list of approved users to whom each user may connect. The NOC server 960 utilizes the password forwarded by the network access server 930 to perform After authorizing and authenticating the user at personal computer 910, the NOC server 960 presents the user with the list of approved users to whom he can connect. For each approved user appearing in a contact list, the NOC server 960 also shows whether that user is online or not. As well, given the mobility of computers, the NOC server locates the initiating user as well as the addressee.

For example, the user at personal computer 910 wishes to communicate with the user at personal computer 915, but that user is not online. The user at personal computer 910 needs to contact the user at personal computer 915, via telephone, e-mail, text message, etc., and request that he sign into the system. The user at personal computer 915 goes through the identical process of connecting into the network access server 930 so as to establish his own session 925, and likewise being connected to the NOC server 960 via a preferential Internet backbone 950, along route 975. Once the personal computer 915 is online, the user at personal computer 910 will be able to request a bidirectional video session with personal computer 915. In one embodiment, the user at personal computer 915 must manually accept the bidirectional video session, whereas in a second embodiment, personal computer 915 may be set to an auto-answer mode, where the bidirectional video session will be established upon the request from personal computer 910.

The NOC server 960 will then communicate instructions to personal computer 910 along route 970, and to personal computer 915 along route 975, providing each with a virtual address of the other. At this point, the secure clients in personal computers 910 and personal computers 915 will initiate a peer-to-peer connection over the preferential Internet backbone 950, along route 980. Personal computers 910 and 915 will exchange bidirectional video in this peer-to-peer mode along route 980. The personal computers 910 and 915 will remain in contact with the NOC server 960 along routes 970 and 975, respectively, so that the NOC server 960 may continue to provide control functions, but the video stream will not be sent to the NOC server 960. Eliminating the need to pass the video and audio data through the NOC server 960 provides for enhanced performance and security.

Instead of a personal computer, a user may use a room system, which is a videoconferencing station that typically includes large monitors with a wide-angle camera and serves groups of people who meet in a room and conference with other groups at remote locations. If the room system has an Internet connection, it would interface to the videoconferencing system in the manner of Personal Computer 915.

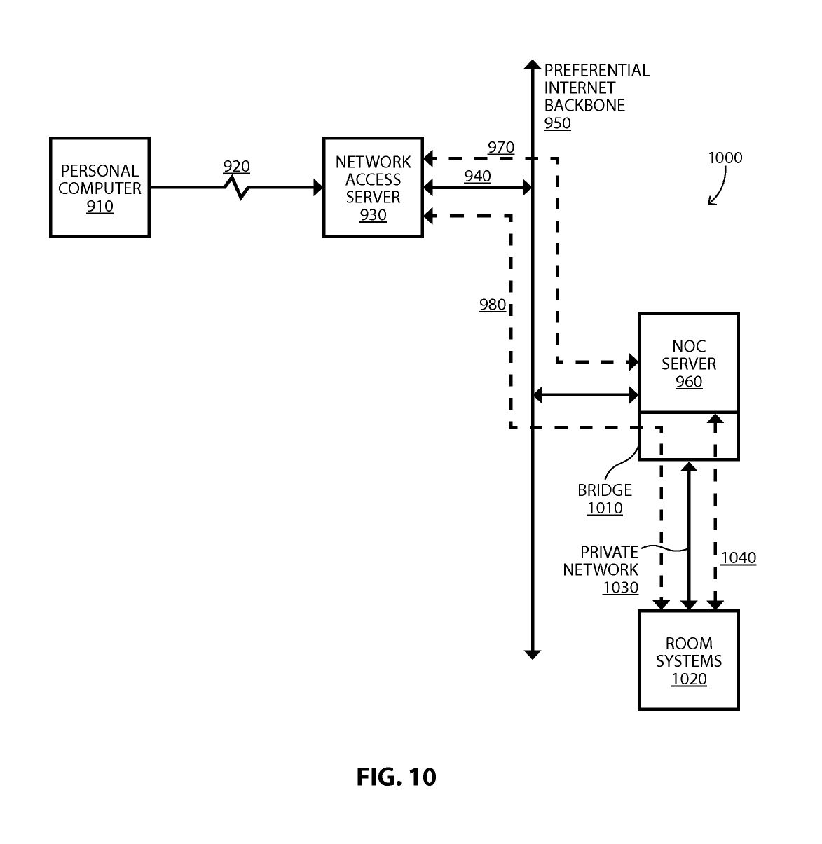

FIG. 10 shows an implementation 1000 in which one of the users is using a room system 1020 which instead of having an Internet connection has a private network 1030. The privately networked room system 1020 connects to the NOC server 960 through a hardware bridge 1010. The room system 1020 communicates with the NOC server 960 along route 1040, allowing for the NOC server 960 to perform the authorization and authentication functions. The bridge 1010 also serves as a conduit for the video signals, as they travel along path 980 between personal computer 910 and the room system 1020. As path 980 is routed partially on the preferential Internet backbone 950 and partially on the private network 1030, a high bandwidth is available, resulting in excellent image quality and reduced latency. As well, the NOC can provide enhanced video and audio exchange capabilities by providing features such as automated or individually directed control room activities. For example, all users' images can be arranged around an enlarged central image provided for the speaker or a desired illustration.

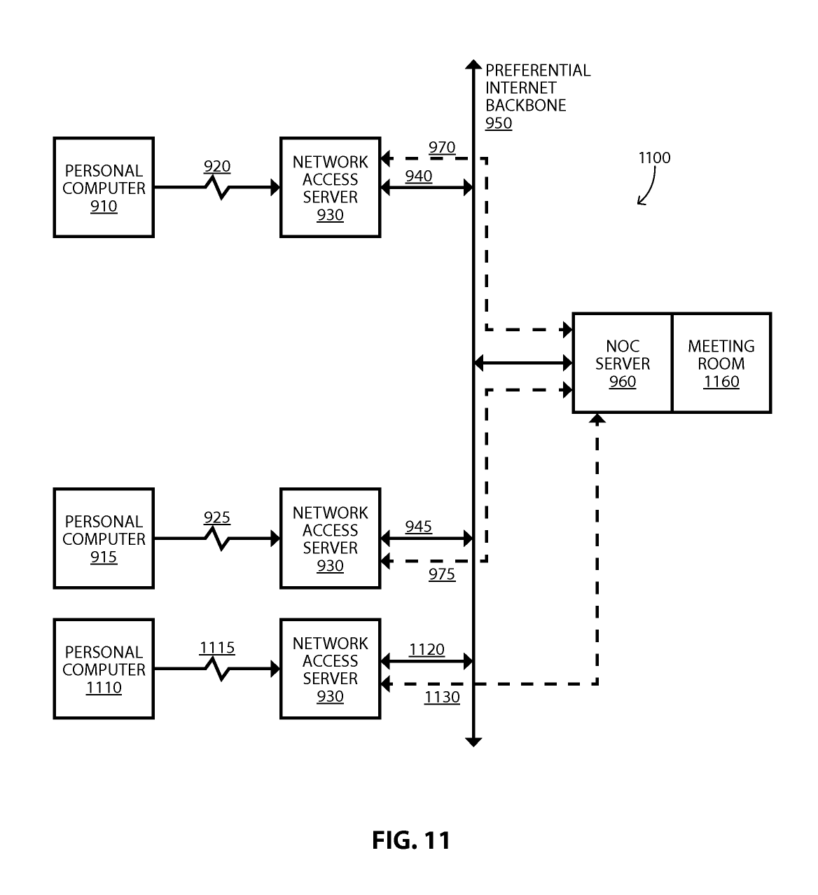

FIG. 11 shows another implementation 1100, in which three or more users are participating in a videoconference. In this situation, the users log into a meeting room 1160 which is provided at the NOC server 960. The meeting room 1160 multiplexes each incoming video signal, and sends a copy to the other participants. Each participant will see each other participant in the video conference call, providing for enhanced security, as no one may monitor a video conference unless they are a participant and their presence is seen by all other participants. One or more of the participants in a videoconference with three or more participants may be employing a room system with a private network that interfaces to the invention through a hardware bridge located at the NOC server, as previously described and shown in FIG. 10.

In another embodiment, the secure client can be tailored for a particular application or industry, such as having the video only take up part of the screen, with the remainder of the screen dedicated to another task, such as displaying a user-completed form.

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A system for sending over the Internet first audio/video and medical data from a first location, and receiving over the Internet a reproduction of said first audio/video and medical data at a second location, and sending over the Internet second audio/video data from said second location, and receiving over the Internet a reproduction of said second audio/video data at said first location, said system comprising:
a. a means for converting said first audio/video and medical data in said first location into a first stream of packets to be sent over the Internet;
b. a means for converting said second audio/video data in said second location into a second stream of packets to be sent over the Internet;
c. a means for converting said first stream of packets in said second location into said reproduction of said first audio/video and medical data to be presented in said second location;
d. a means for converting said second stream of packets in said first location into said reproduction of said second audio/video data to be presented in said first location;
e. a means for said first location and said second location to send and receive said first stream of packets and said second stream of packets over a private Internet backbone including at least one preferential route supplied by arrangement with a data network provider using fiber optic lines; and
wherein the system sends said first audio/video and medical data and said second audio/video data and receives said reproduction of said first audio/video and medical data and said reproduction of said second audio/video data in a full duplex, full motion, and live manner.

2. The system of claim 1,
a. wherein each of said means for respectively converting said first and second audio/video data comprises:
i. an audio/video encoder/decoder producing an audio/video encoder output data stream;
ii. a packetizer accepting a processed form of said audio/video encoder output data stream after processing of said audio/video encoder output data stream between said audio/video encoder/decoder and said packetizer, said packetizer producing a stream of unbuffered packets; and
iii. a modem sending and accepting said first or second stream of packets respectively over said Internet, said first or second streams of packets being produced by buffering of said stream of unbuffered packets, and
b. wherein each of said means for respectively converting said first and second streams of packets comprises:
i. a modem receiving said first or second stream of packets respectively from the Internet; and
ii. an audio/video encoder/decoder receiving an audio/video decoder input data stream from said modem after processing of said first and second streams of packets between said modem and said audio/video encoder/decoder.

3. The system of claim 1, wherein said first and second streams of packets are transmitted over said preferential Internet backbone in a peer-to-peer mode between said first location and said second location.

4. The system of claim 2, wherein said first and second streams of packets are transmitted over said preferential Internet backbone in a peer-to-peer mode between said first location and said second location.

5. The system of claim 3, wherein said means for said first location and said second location to exchange said first stream of packets and said second stream of packets over a preferential Internet backbone, comprises a network access server by which said first and second locations access said preferential Internet backbone, and thereby access a network operations center (NOC) server, which performs authorization and authentication functions upon being accessed by an authorized user at each location, and which contains a database for the authorization and authentication functions, said database also containing a list of at least one other authorized user that a particular authorized user may contact for a videoconference,
said NOC server passing virtual address information between said first and second locations for said first and second locations to thereafter communicate in the peer-to-peer mode over said preferential Internet backbone, without said first and second streams of packets passing through said NOC server.

6. The system of claim 4, further comprising a network access server whereby said first and second locations access said preferential Internet backbone; and
a NOC server which performs authorization and authentication functions upon being accessed by an authorized user at each location, and which contains a database for the authorization and authentication functions, said database also containing a list of each user that a particular authorized user may contact for a videoconference,
said NOC server passing virtual address information between said first and second locations, allowing said first and second locations to thereafter communicate in said peer-to-peer mode over said preferential Internet backbone, without said first and second streams of packets passing through said NOC server.

7. A system for sending over the Internet first audio/video and medical data from a first location, and receiving over a private network a reproduction of said first audio/video and medical data at a second location, and sending over the private network second audio/video data from said second location, and receiving over the Internet a reproduction of said second audio/video data at said first location, said system comprising:
a. a means for converting said first audio/video and medical data in said first location into a first stream of packets to be sent over the Internet;
b. a means for converting said second audio/video data in said second location into a second stream of packets to be sent over the private network;
c. a means for converting said first stream of packets in said second location into said reproduction of said first audio/video and medical data to be presented in said second location;
d. a means for converting said second stream of packets in said first location into said reproduction of said second audio/video data to be presented in said first location;
e. a means for said first location and said second location to send and receive said first stream of packets and said second stream of packets via the Internet and the private network,
wherein the exchange of the streams of packets via the Internet is conducted over a preferential Internet backbone including at least one preferential route supplied by arrangement with a data network provider using fiber optic lines,
said system sending said first audio/video and medical data and said second audio/video data and receiving said reproduction of said first audio/video and medical data and said reproduction of said second audio/video data in a full duplex, full motion, and live manner.

8. The system of claim 7, wherein the second location is a room system with the private network, which communicates with a NOC server through a hardware bridge,
wherein said NOC server performs authorization and authentication functions upon being accessed by an authorized user at each location, and which contains a database for the authorization and authentication functions, said database also containing a list of at least one other authorized user that a particular authorized user may contact for a videoconference, and
wherein said NOC server communicatively couples said first location and said second location to send and receive said first stream of packets and said second stream of packets over said preferential Internet backbone.

9. A system for sending over the Internet audio/video data from three or more locations, a first one of which also sends medical data, and receiving over the Internet at each location a reproduction of audio/video data from each other location and a reproduction of the medical data at a second one of the other locations, said system comprising:
a1. a means for converting said audio/video data in each location into a stream of packets to be sent over the Internet;
a2. a means for sending said medical data from the first location to the second location;
b. a means for allowing said three or more locations to transmit streams of packets over a preferential Internet backbone including at least one preferential route supplied by arrangement with a data network provider using fiber optic lines, wherein said means comprises a network access server which allows said three or more locations to access said preferential Internet backbone, and thereby access a NOC server,
which said NOC server performs authorization and authentication functions upon being accessed by an authorized user at each location, and which contains a database for the authorization and authentication functions, said database also containing a list of at least one other authorized user that a particular authorized user may contact for a videoconference,
said NOC server creating a virtual meeting room in which said three or more locations may conduct a videoconference, with the NOC server multiplexing audio/video data from each of the three or more locations, and preparing for each location a stream of packets comprising a presentation of the audio/video data from each other location;
d. a means for transmitting from the NOC server to each location said stream of packets comprising a presentation of the audio/video data from each other location;
e1. a means for converting at each location said stream of packets comprising a presentation of the audio/video data from each other location into a reproduction of said presentation of said audio/video data from each other location;
e2. a means for receiving said medical data from the first location at the second location;
f. said system sending said audio/video data from each location and receiving said reproduction of said audio/video data from each other location for presentation in a full duplex, full motion, and live manner.

10. The system of claim 9, wherein the presentation of the audio/video data from each of the other locations includes an enlarged image of the video data from a first one of said other locations.

11. The system of claim 10, wherein the presentation of the audio/video data from each of the other locations, includes an enlarged image of the video data from a second one of said other locations.

12. The system of claim 10, wherein the system selects the video data for the enlarged image from the first one of said each other locations when a user at the first location begins to speak.

13. The system of claim 11, wherein the system selects the video data for the enlarged image from the second one of said each other locations instead of the first one when a user at the second location begins to speak.
